(19) United States
(12) Patent Application Publication
(10) Pub. No.: US 2012/0010736 A1
(43) Pub. Date: Jan. 12, 2012

(54) SPOTTING MULTIMEDIA

(75) Inventors: Peter S. Cardillo, Atlanta, GA (US); Marsal Gavalda, Sandy Springs, GA (US)

(73) Assignee: Nexidia Inc., Atlanta, GA (US)

(21) Appl. No.: 12/833,244

(22) Filed: Jul. 9, 2010

(51) Int. Cl. G06F 17/00; G06N 5/02

(52) U.S. Cl. 700/94; 706/54

(57) ABSTRACT

A method for detecting sections of a known input in an unknown input includes processing the known input to form a series of discrete-valued feature values associated with corresponding time locations in the known input. Index data associating a plurality of the feature values each with one or more time locations in the known input is then formed. The unknown input is processed to form a series of discrete-valued features values. A time offset between the unknown input and the known input is determined by determining time locations in the known input associated with the feature values of the unknown input. Determining the time offset may include maintaining a distribution of time offsets based on successive determined time locations of the feature values of the unknown input.

This invention relates to spotting occurrences of multimedia content.

There are a number of applications in which an ability to identify a multimedia clip, for example, a song, a television commercial, or a scene from a motion picture, can be useful. For example, it may be useful to identify a song based on audio captured of the song being played. One approach is to compute a “fingerprint” of the song based on the audio characteristics of the song, and looking up that fingerprint in a precomputed set of fingerprints to find a suitably close match.

### SUMMARY

In one aspect, in general, a method for detecting sections of a known input in an unknown input includes processing the known input to form a series of discrete-valued feature values associated with corresponding time locations in the known input. Index data associating a plurality of the feature values each with one or more time locations in the known input is then formed. The unknown input is processed to form a series of discrete-valued features values. A time offset between the unknown input and the known input is determined by determining time locations in the known input associated with the feature values of the unknown input. Determining the time offset may include maintaining a distribution of time offsets based on successive determined time locations of the feature values of the unknown input.

In another aspect, in general, a method for detecting sections of a known input in an unknown input includes accepting a series of discrete-valued features values determined by processing the known input to form the series. Index data is formed and maintained to associate the discrete-valued feature values determined by processing the known input each with one or more time locations in the known input. A series of discrete-valued features values determined by processing the unknown input is accepted, and a time offset between the unknown input and the known input is determined using the index data by determining time locations in the known input associated with the accepted feature values of the unknown input.

Aspects may include one or more of the following features.

After determining the time offset between the unknown input and the known input, at least a portion of the series from the known input and the series from the unknown input are tracked according to the determined offset. In some examples, the step of determining the time offset using the index data is repeated after the tracking detects a mismatch between the series from the known input and the series from the unknown input.

The known and unknown inputs comprise a media input and the feature values are formed from a signal component that includes at least an audio component and a video component of the media input.

Forming the discrete-valued features comprises signal processing the signal component and quantizing a result of the signal processing. For instance, the signal processing comprises processing of a series of frames of the signal component to form a series of processed frames, and quantizing the result of the signal processing comprises jointly quantizing sets of multiple of the processed frames. In some examples, quantizing the result of the signal processing comprises forming a vector representation of the result of the signal processing and quantizing the vector representation. In some examples, the sets of multiple processed frames comprise non-consecutive processed frames (e.g., a set of six frames spaced at irregular frame intervals).

The index data comprises an inverted index that provides a mapping from quantized values to the time locations in the known input.

Determining the time offset includes maintaining a distribution of time offsets based on successive determined time locations of the feature values of the unknown input. In some examples, determining the time offset further includes identifying a peak value in the maintained distribution. In some examples, maintaining the distribution comprises maintaining a distribution according at a lower time resolution than a period of the forming of the feature values.

The known input comprises a first version of a multimedia production and the unknown input comprises a second version of a multimedia production, and the method further includes identifying correspondence of segments of the second version of the production with segments of the first version of the production.

The accepting the feature values determined from the unknown input includes receiving said feature values from a user media player at a server system at which the index data is maintained and the time offset is determined. For instance, the user media player comprises an audio-video monitor (e.g., a television set).

Accepting the features determined from the known input comprises accepting features determined from programming available to display on the media player.

The index data is dynamically updated to depend on live broadcasts available for presentation on the media player.

Accepting the feature values determined from the unknown input comprises accepting features determined from programming presented on the media player.

The programming presented on the media player is determined according to the determined time offset between the unknown input and the known input.

Accepting the feature values determined from the unknown input includes receiving said feature values at a computational module located at a user media player at which at least part of the determining of the time offset is determined. In some examples, the method further comprises providing at least some of the index data and/or the series of feature values from the known input from a server system at which the index data is maintained to the computation module at the user media player.

In another aspect, in general, a system for detecting sections of a known input in an unknown input includes an input for accepting a series of discrete-valued features values determined by processing the known input to form the series. The system includes a storage for maintaining index data that associates discrete-valued feature values determined by processing the known input each with one or more time locations in the known input. An input is provided for accepting a series of discrete-valued features values determined by processing the unknown input. An offset detection module is configured to use the index data to determining a time offset between the unknown input and the known input by determining time locations in the known input associated with the feature values of the unknown input.

In another aspect, in general, a system for monitoring programming includes a signal processor at a user media player configured to process unknown programming presented at the media player to form a series of discrete-valued feature values. A storage is provided for maintaining index data that associates discrete-valued feature values determined by processing known programming with one or more time locations in the known programming. A programming detection system is configured to use the index data to identify the unknown programming according to time locations in the known programming of the unknown programming determined using the index data. In some examples, one or both of the storage for the index data and the programming detection system are hosted on a server remote from the media player, and the server is configured to receive input from multiple media players. In some examples, the system includes a presentation system configured to adapt output of the media player according to the detected programming (e.g., advertising targeted to match the detected programming).

Advantages can include one or more of the following.

The input processing required for certain versions of the approach may be significantly lower than for prior approaches, such as approaches that use relatively detailed spectral characteristics and time alignment. Because sections of unknown input generally correspond to known input for relatively long sections (e.g., 10 seconds or more) the matching information can be accumulated to provide a relatively high accuracy match. In applications that require greater certainty of match, the approach can efficiently focus more computationally intensive approaches to the sections in which a match is plausible.

Other features and advantages of the invention are apparent from the following description, and from the claims.

### DESCRIPTION OF DRAWINGS

FIG. 1 is a block diagram of a clip spotting system; and

FIGS. 2A-C illustrate a clip spotting operation;

FIG. 3 is a programming detection system.

### DESCRIPTION

### 1 Clip Spotter

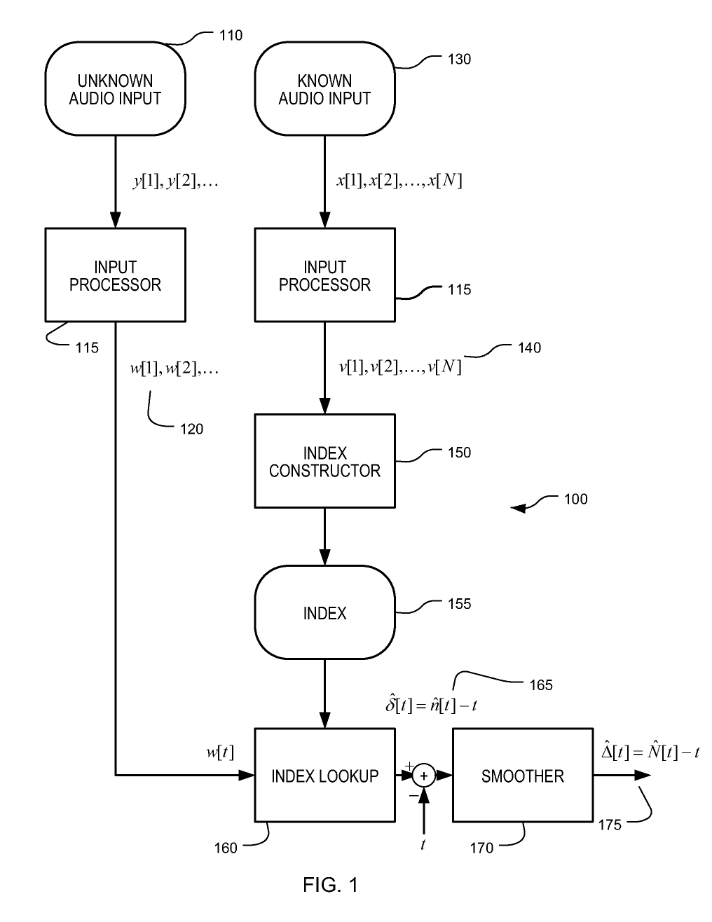

Referring to FIG. 1, a first example of a multimedia clip spotting system 100 processes unknown input 110 and provides as an output an estimate of an offset \hat{Δ} 175 of where the unknown input occurs in a corpus of known input 130. When the unknown input 110 is a portion of the known input, then \hat{Δ} is expected to be constant, representing the start time of the portion of the known input corresponding to time zero of the unknown input. More generally, the unknown input may include a number of sections, some of which each correspond to a section of the known input. In such a case, during a section of the unknown input that has a corresponding section in the known input, during that section the output \hat{Δ} is expected to have a value equal to the difference between the start time of the section in the known input and the start time of the section in the unknown input.

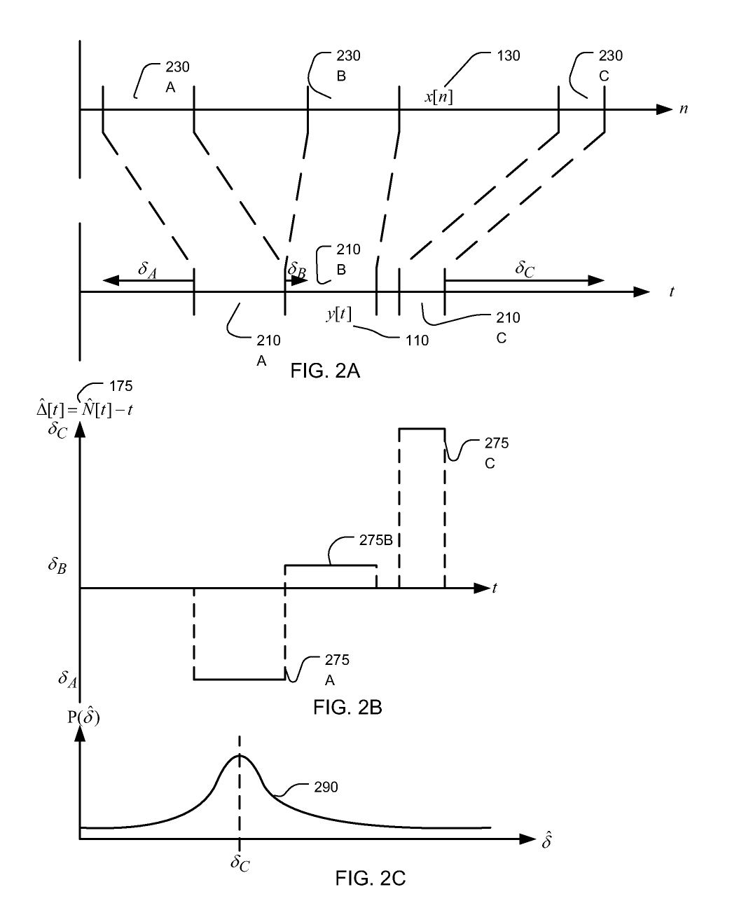

Referring to FIG. 2A, an illustration of an unknown input 110 includes three sections 210A-C, which correspond to sections 230A-C, respectively, in a known input 130. Other parts of the unknown input 110 do correspond to parts of the known input. The time offsets of the three sections are denoted δ_{A}, δ_{B}, and δ_{C} respectively, the sizes of which are illustrated in FIG. 2A. Referring to FIG. 2A, an ideal output \hat{Δ}[t] has a constant value δ_{A} 275A during the unknown section 210A, a constant value δ_{B} during section 210B, and value δ_{C} during section 210C. At other times \hat{Δ}[t] is undefined or some default value (not illustrated).

Referring again to FIG. 1, the clip spotting system 100 makes used of an input processor 115, which is applied in the same manner both to the unknown input 110 and the known input 130. Generally, each of the inputs is considered to comprise a sequence of “frames” of input. As an example, in the case of audio input, the time signal can be considered to consist of a sequence of frames, each determined by applying a time window (e.g., 20 ms. width) to the input time signal, and moving the window a fixed frame duration (e.g., by 10 ms.) between each frame calculation. The sequence of input signal frames is denoted y[1], y[2], . . . for the unknown input 110 and x[1], x[2], . . . for the known input.

In a number of embodiments, the input processor 115 accepts the sequence of input frames, and produces a sequence of quantized outputs (i.e., reduced data outputs represented as values from a range of discrete values or other finite set). In at least some implementations, the unknown sequence y[t] is processed by the input processor 115 to produce a quantized sequence w[t] such that each quantized value w[t]ε{0, . . . , Q−1}. Therefore, each quantized feature belongs to a discrete set of possible outputs (i.e., is “discrete valued”). Similarly, the sequence x[t] is processed to produce the quantized sequence v[t].

The sequence v[t] for the known input is processed by an index constructor 150 to produce an index 155. Generally, the index 155 includes data structures such that given a quantized value q a time n is identified such that v[n]=q if such an n exists. In some embodiments, Q is large enough (e.g., 16 million), and potentially larger that the length N of the known input (e.g., 20 hours yielding approximately 7 million inputs), such that for any particular quantized value q, generally none or a small number of possible values of n satisfy v[n]=q.

An index lookup 160 implements the mapping from q to an output that is null or a specific value (or values) of n such that v[n]=q. For instance, if multiple values of n satisfy this condition, one is chosen at random, or alternatively the entire set of times is returned. Note that under ideal circumstances in which each value of q results in either a null or a value n, in the example illustrated in FIG. 2A, suppose that the first section 210A begins at a time t_{A}, then applying w[t_{A}] to the index lookup 160 outputs t_{A}+δ_{A}. Applying successive quantized values w[t_{A}+k] produces the sequence t_{A}+δ_{A}+k, for k=1, 2, . . . . Therefore, subtracting t from the outputs of the index lookup 160 ideally produce the runs of constant values as illustrated in FIG. 2B.

In practice, the sequence of quantized values w[t_{A}], w[t_{A}+1], . . . is not exactly equal to v[t_{A}+δ_{A}], v[t_{A}+δ_{A}+1], . . . during the first section interval 210A. If we assume that only a relatively small fraction p match, then the non-matching times produce either a null output from the index lookup, or a random value \hat{n}. Referring to FIG. 2C, maintaining a histogram of values \hat{δ}=\hat{n}−t is expected to produce a peak at the value of \hat{δ} corresponding to the actual offset. For instance, an example of a histogram determined during the third known section 210C is expected to have a peak at \hat{δ}=δ_{C}.

In some embodiments, a smoother 170 maintains a decaying average histogram such that after a transition into a repeated section, a peak at the actual offset is expected to grow to a maximum. For example, suppose that only p=0.04 of the frame match, and the decaying average is over a duration of K=1,000, then one would expect the peak to have a height of 40. The other roughly 960 are statistically unlikely to produce a similarly high peak because the values are null or randomly distributed.

In some embodiments, the smoother maintains the decaying average. For instance, the histogram h[δ] is maintained in a sparse representation and is initialized to h[δ]=0 for all δ. Each quantized value w[t] for the unknown input passes to the index lookup, which either produces a null output, or produces a value \hat{n}. The histogram is updated h[\hat{n}−t]←h[\hat{n}−t]+1. If the maximum value max_{δ} h[δ] exceeds a threshold hₜₕᵣₑₛₕ, then the smoother outputs \hat{Δ}=arg max_{δ} h[δ]. Before the next frame, the histogram is updated h[δ]←(K−1/K)h[δ] for all non-zero entries, can entries that approach zero are zeroed.

In some embodiments, the histogram h[δ] is not maintained with the a resolution equal to the resolution of the analysis frames (e.g., 10 ms.). For example, the histogram may be binned at a coarser resolution, for instance, at a resolution of 1 sec. or 10 sec., or within time sections identified by other means (e.g., video scene boundaries) thereby being able to identify the offset that that same resolution.

In some embodiments, the input processor 115 (see FIG. 1) performs a relatively crude analysis of the acoustic features. For example, if the each input x[n] to the input processor represents a windowed time waveform, the corresponding quantized output v[n] is determined as follows:

For each time n, x[n] is processed to compute a scalar power p[n]. A time derivative of power is approximated as a first difference dp[n]=p[n]−p[n−1] and a second derivative of power is approximated as a second difference d²p[n]=dp[n]−dp[n−1]=p[n]−2p[n−1]+p[n−2]. A further energy feature r[n] represents a ratio of high frequency to low frequency energy. These four features combined (“stacked”) to form a vector:

$$f [ n ] = [ \begin{matrix}p [ n ] \\ dp [ n ] \\ {d}^{2} p [ n ] \\ r [ n ]\end{matrix} ]$$

Each component of this vector is scalar quantized, in this example, to one of two levels. This quantization is equivalent to comparing each value to a fixed or adaptive threshold (e.g., a running average or median of that feature). This yields a binary 4-dimensional vector q[n]. Due to the binary nature of the entries, this vector can take on one of 2⁴=16 values.

At each time, a set of six time offsets t₁, t₂, . . . , t₆ are used to form a stacked quantized vector, which is output:

$$v [ n ] = [ \begin{matrix}q [ n + {t}_{1} ] \\ q [ n + {t}_{2} ] \\ ⋮ \\ q [ n + {t}_{6} ]\end{matrix} ]$$

Note that v[n] can take on one of 16⁶=16M values (M=2²⁰). In some examples, the offset times span approximately one second of input, and may be chosen to non-uniformly sample that interval. Therefore, the quantized vector v[n] is not necessarily made up from a contiguous section of time waveform of the input rather being composed of characteristics of a set of disjoint sections are fixed offsets.

In some examples, the index 155 comprises an inverted index that uses a binary tree structure to find the set of possible time offsets in a sequence of up to 16 links in the tree structure.

In examples in which the known input is composed of a set of discrete sections (e.g., movie scenes, commercials, songs), the unknown input is at least conceptually formed as a concatenation of sections. A peak in the histogram determined by the smoother 170 would therefore generally correspond to one of the boundaries of the sections concatenated in the known input.

In some examples, the output of a clip spotter 100 as illustrated in FIG. 1 is passed to a secondary verification processor, which makes a more detailed analysis of the match between the unknown speech and the known speech. For example, a real-valued similarity between the features f[n] computed for the known and the unknown input at the putative offset is used for further verification of the match.

Note that alternative features can be used within the approach described above. For example, the number of levels for scalar quantization may be greater than two, for example, quantizing into one of four levels yielding two bits per feature. In some alternatives, a vector quantization approach can be used to partition the multiple dimensional feature vector space into discrete regions.

A number of examples are described in this document with reference to audio input in which the features are based on time signals. In other examples, features of video signals, for instance, based on individual or groups of frames of video can be used in a like manner. For example, overall image frame intensity is used in a like manner that frame audio power is used. In some examples, the audio and the video based features are combined into a single quantized feature.

In some examples, not every frame in the known and/or the unknown input yields a processed input for that frame. For example, in some examples, a speech activity detector is used to identify those frames that include speech. In some examples only the frames that include speech are used, while in other examples, only frames that do not include speech are used. In some examples, a music detector is used to either exclude or include frames with music. In some examples, a silence detector is used to exclude frames with what is deemed to be silence or background volume.

### 2 Use Cases

A number of different uses of the clip spotting approach described above are outlined below.

### 2.1 Conformance Analysis

When a motion picture is dubbed into a foreign language, the music and sound effects are typically intended to remain the same as in the source language for the motion picture. In an ideally dubbed motion picture, the source language audio track is treated as the known input and the dubbed language audio track is treated as the unknown input. If the speech frames are excluded from the processing, then a constant offset between the versions should be detected by the clip spotting approach, for example, based on background sounds and music rather than dialog.

If the two versions do not conform, for example, because the music track is not synchronized properly (e.g., the offset drifts in time), or is incorrectly selected, then a deviation from a constant offset may be detected when there is lack of synchronization.

In a related case, a comparison on a theatrical versus a director's cut of a motion picture identifies the parts that are inserted as extra scenes. Such a case may be based on either the non-speech, the speech, or both types of frames.

In some examples, the known input is synchronized with a text source, for example, as described in U.S. Pat. No. 7,487,086, titled “Transcript Alignment,” which is incorporated herein by reference. Then association of sections of the unknown input with sections of the known input also provides the association of the unknown sections with sections of the synchronized text source. As a specific use, this approach may be used to confirm that all sections of dialog in the text source are present in the unknown input and/or identify those sections of dialog that are missing.

### 2.2 Advertising Detection

In another use example, a set of television advertisements are concatenated to form the known input, with each advertisement having a relatively short duration. An unknown input includes program content, interspersed with advertisements. The clip spotting approach is used to identify occurrences of the advertisements, for example, to log or count their occurrences.

### 2.3 Viewer Monitoring

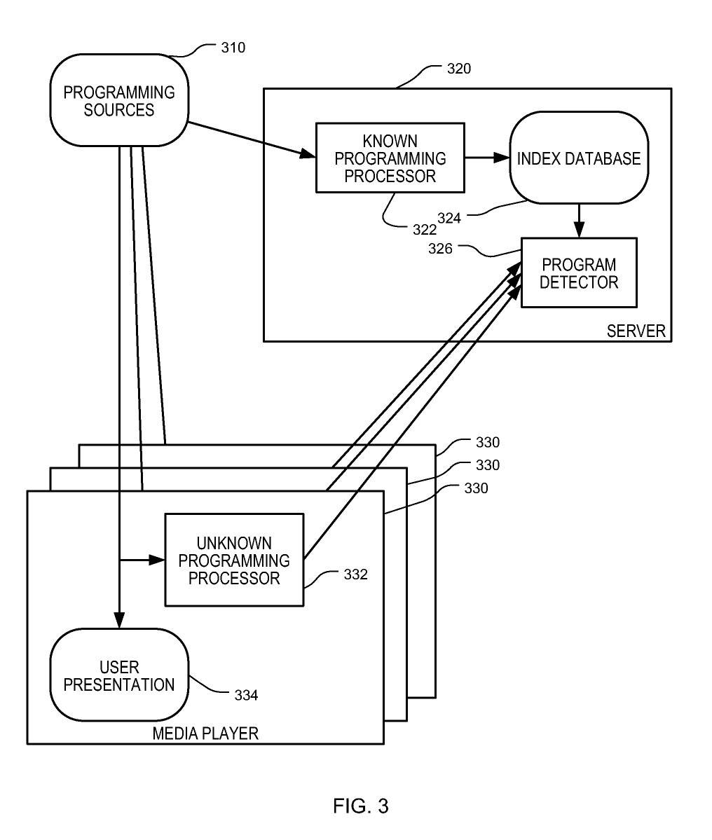

Referring to FIG. 3, in another use, which may be related to the advertising detection use, a viewer of audio-video programming uses a media player 330 (e.g., a television monitor) that can accept inputs from a number of different sources, including live/streaming programming, programming on media (e.g., DVD), and content previously received and cached in a recorder for time-shifted viewing. Original sources of the programming 310 may include, for example, publishers of content, television networks, etc. The media player 330 includes a processor 332 than has access to the content being presented 334, for example, by accessing the audio output and/or the video output of the programming being presented.

In one embodiment, the monitor includes a processor 332 that performs the function of the input processor 115 shown in FIG. 1 to produce a sequence of quantized features. The processor is in data communication with a remote server 320, for example, over a data network link.

The server 320 includes an index database 324 that is created by applying a processor 322 to content of the programming sources 310, which may include a corpus of relatively static content, such as frequently viewed motion pictures. The index may be further augmented, for instance, with current advertisements that may be presented in various programming, and with indexes into recent live programming. In the latter case, the index may be continually updated to add recent live programming and to remove relatively aged programming.

The server receives the stream of quantized features from the processor at the user's media player, and based on its index, tracks when the viewed content corresponds to sections of the content known to the server.

Various types of information can be determined based on such monitoring, for example, that can be useful for determining whether advertising is actually being viewed rather than skipped.

In some examples, the server provides information and/or content to the user's monitor based on the detected content being viewed. For example, advertising may be presented to the user based on the content being viewed. Such advertising may take the form of advertisements framing the content. In some examples, user preferences and interests are determined based on the content that is detected. Such preferences may then be used for matching advertising and/or content recommendations to the user.

The division of processing between a processor in the user's monitor and a remote server may be different in other implementations. For example, some of the index-based matching may be delegated to the user's processor, and streams of quantized features provided from the user's media player are sent only when the matching process shows that the unknown input does not match the content used to construct the index. In one such example, when the remote server detects that particular content is being played on the user's media play, it may download the expected features as a sequence, or a portion of the index, for the media player to follow. If in following that downloaded sequence or index, the player detects a mismatch, it reverts to streaming the quantized features to the remote server to resolve what content is then being played.

In some examples, the server keeps track, for each client (e.g., media player), of time of last received quantized features received from the client and match result, so when the next features are received from same client, the server can look first at the most likely place in the catalog, for instance, last match time plus the elapsed time, thereby saving computation since most of the time the user won't change program.

In some examples, a user profile is built over time so that certain portions of the catalog are looked at searched when looking up unknown quantized features. For example, if based a viewer's past history (with the potential help from metadata, related programs and preferences, etc) it is determined that user likes soccer, portions of the index related to soccer or sports may be searched before other portions. More generally, the index may be partitioned according to a criterion, such as by content class (e.g., sports), and the parts of the index searched in a client specific order.

In some examples, the client device is aware of change of program (e.g., new video source or channel change events are available to the client device). In such an example, the client may generate and send the quantized features only during an initial period of the view the new program until that program is identified. More generally, only certain events (e.g., changing channel, pausing or fast forwarding, etc.) trigger generation and lookup of the features to identify the program and/or identify the new location in the program.

In another example, part of the task of looking up the features is delegated to the player, and the server makes a prediction of the content that is being viewed (e.g., the program and the general time segment of the program) and pushes a portion of the catalog and/or index to the client so that the comparison can be done locally on the client. Only when local features do not match prediction are the quantized features sent to the server.

In some examples, the user's client or media player may be a home television set, while in other examples, it may be a mobile personal device (e.g., cellular telephone/smartphone, tablet computer, etc.).

### 3 Implementations

Various implementations may use software, hardware, or a combination of software and hardware. In some examples, the software may include instructions that are provided for storage in a computer-readable medium, for instance, over a network. In some examples, the software includes instructions for controlling operation of a general-purpose processor. Other examples of instructions include instructions for controlling a virtual processor. In some examples, hardware is used to implement some of the functions described above. For example, the input processor may make use of application specific integrated circuits that accelerate its operation.

It is to be understood that the foregoing description is intended to illustrate and not to limit the scope of the invention, which is defined by the scope of the appended claims. Other embodiments are within the scope of the following claims.

What is claimed is:

1. A method for detecting sections of a known input in an unknown input comprising:
accepting a series of discrete-valued features values determined by processing the known input to form the series;
maintaining index data formed to associate the discrete-valued feature values determined by processing the known input each with one or more time locations in the known input;
accepting a series of discrete-valued features values determined by processing the unknown input;
determining a time offset between the unknown input and the known input using the index data by determining time locations in the known input associated with the accepted feature values of the unknown input.

2. The method of claim 1 further comprising after determining the time offset between the unknown input and the known input, tracking of at least a portion of the series from the known input and the series from the unknown input according to the determined offset.

3. The method of claim 2 wherein the step of determining the time offset using the index data is repeated after the tracking detects a mismatch between the series from the known input and the series from the unknown input.

4. The method of claim 1 wherein the known and unknown inputs comprise a media input and the feature values are formed from a signal component that includes at least an audio component and a video component of the media input.

5. The method of claim 1 wherein forming the discrete-valued features comprises signal processing the signal component and quantizing a result of the signal processing.

6. The method of claim 5 wherein the signal processing comprises processing of a series of frames of the signal component to form a series of processed frames, and wherein quantizing the result of the signal processing comprises jointly quantizing sets of multiple of the processed frames.

7. The method of claim 6 wherein quantizing the result of the signal processing comprises forming a vector representation of the result of the signal processing and quantizing the vector representation.

8. The method of claim 6 wherein the sets of multiple processed frames comprise non-consecutive processed frames.

9. The method of claim 1 wherein the index data comprises an inverted index that provides a mapping from quantized values to the time locations in the known input.

10. The method of claim 1 wherein determining the time offset includes maintaining a distribution of time offsets based on successive determined time locations of the feature values of the unknown input.

11. The method of claim 10 wherein determining the time offset further includes identifying a peak value in the maintained distribution.

12. The method of claim 10 wherein maintaining the distribution comprises maintaining a distribution according at a lower time resolution than a period of the forming of the feature values.

13. The method of claim 1 wherein the known input comprises a first version of a multimedia production and the unknown input comprises a second version of a multimedia production, and the method further includes identifying correspondence of segments of the second version of the production with segments of the first version of the production.

14. The method of claim 1 wherein the accepting the feature values determined from the unknown input includes receiving said feature values from a user media player at a server system at which the index data is maintained and the time offset is determined.

15. The method of claim 14 wherein the user media player comprises an audio-video monitor.

16. The method of claim 14 wherein accepting the features determined from the known input comprises accepting features determined from programming available to display on the media player.

17. The method of claim 16 wherein the index data is dynamically updated to depend on live broadcasts available for presentation on the media player.

18. The method of claim 16 wherein accepting the feature values determined from the unknown input comprises accepting features determined from programming presented on the media player.

19. The method of claim 18 further comprising identifying the programming presented on the media player according to the determined time offset between the unknown input and the known input.

20. The method of claim 1 wherein accepting the feature values determined from the unknown input includes receiving said feature values at a computational module located at a user media player at which at least part of the determining of the time offset is determined, and wherein the method further comprises providing at least some of the index data from a server system at which the index data is maintained to the computation module at the user media player.

21. A system for detecting sections of a known input in an unknown input comprising:
an input for accepting a series of discrete-valued features values determined by processing the known input to form the series;
a storage for maintaining index data that associates discrete-valued feature values determined by processing the known input each with one or more time locations in the known input;
an input for accepting a series of discrete-valued features values determined by processing the unknown input; and
an offset detection module configured to use the index data to determining a time offset between the unknown input and the known input by determining time locations in the known input associated with the feature values of the unknown input.

22. A system for monitoring programming comprising:
a signal processor at a user media player configured to process unknown programming presented at the media player to form a series of discrete-valued feature values;
a storage for maintaining index data that associates discrete-valued feature values determined by processing known programming with one or more time locations in the known programming; and
a programming detection system configured to use the index data to identify the unknown programming according to time locations in the known programming of the unknown programming determined using the index data.

23. The system of claim 22 wherein at least one of the storage for the index data and the programming detection system are hosted on a server remote from the media player, and wherein the server is configured to receive input from multiple media players.

24. The system of claim 22 further comprising:
a presentation system configured to adapt output of the media player according to the detected programming.
